(19) United States
(12) Patent Application Publication
(10) Pub. No.: US 2014/0193682 A1
(43) Pub. Date: Jul. 10, 2014

(54) LITHIUM ION SECONDARY BATTERY AND METHOD FOR MANUFACTURING LITHIUM ION SECONDARY BATTERY

(71) Applicants: Shinji Suzuki, Kariya-shi (JP); Taira Saito, Miyoshi-shi (JP)

(72) Inventors: Shinji Suzuki, Kariya-shi (JP); Taira Saito, Miyoshi-shi (JP)

(21) Appl. No.: 14/241,719

(22) PCT Filed: Aug. 30, 2011
(86) PCT No.: PCT/JP2011/004830

§ 371 Date: Feb. 27, 2014

(51) Int. Cl. H01M 4/38; H01M 10/04; H01M 10/0525; H01M 4/66

(52) U.S. Cl. CPC H01M 4/38; H01M 4/661; H01M 10/0431; H01M 10/0525
USPC 429/94; 29/623.1

(57) ABSTRACT

A ratio La/Lb between lengths La and Lb is defined as a first ratio, and a ratio Sa/Sb between areas Sa and Sb is defined as a second ratio. The first and second ratios are positioned within a region surrounded by lines connecting five points P1 to P5 in a coordinate system in which the first and second ratios are taken as the respective coordinate axes thereof. The point P1 has a first ratio of 0.273 and a second ratio of 0.099. The point P2 has a first ratio of 0.636 and a second ratio of 0.099. The point P3 has a first ratio of 0.836 and a second ratio of 0.496. The point P4 has a first ratio of 0.545 and a second ratio of 0.496. The point P5 has a first ratio of 0.236 and a second ratio of 0.215.

### CROSS-REFERENCE TO RELATED APPLICATIONS

This application is a national phase application of International Application No. PCT/JP2011/004830, filed Aug. 30, 2011, the content of which is incorporated herein by reference.

### TECHNICAL FIELD

The present invention relates to a lithium ion secondary battery having an electrode terminal connected to a power generation element that performs charging and discharging and to a method of manufacturing the lithium ion secondary battery.

### BACKGROUND ART

A lithium ion secondary battery has a positive electrode plate, a negative electrode plate, and a separator arranged between the positive electrode plate and the negative electrode plate. In the lithium ion secondary battery, charging and discharging are performed as a result of lithium ions moving between the positive electrode plate and the negative electrode plate. A positive electrode terminal is connected to the positive electrode plate and a negative electrode terminal is connected to the negative electrode plate. The positive electrode terminal and the negative electrode terminal are used to connect the lithium ion secondary battery to a load.

In the lithium ion secondary battery, there is a risk that lithium deposits when charging and discharging are repeated or overcharging is performed. Therefore, to prevent the lithium from depositing, a technology has been proposed that controls the charging and discharging of the lithium ion secondary battery.

### CITATION LIST

### Patent Literature

Patent Literature 1: Japanese Patent Application Laid-Open No. 2009-026705

### SUMMARY OF INVENTION

### Technical Problem

Deposition of lithium is not only influenced by the charging and discharging of a lithium ion secondary battery, but in some cases, it is also influenced by a structure of the lithium ion secondary battery. In other words, depending on the structure of the lithium ion secondary battery, lithium sometimes easily deposits.

### Solution to Problem

A lithium ion secondary battery according to the present invention has a power generation element and electrode terminals. The power generation element, in which electrode plates are rolled together with a separator interposed therebetween, performs charging and discharging. The electrode plate has a current collector and an active material layer that covers part of the current collector. The electrode terminal extends along an exposed region on the current collector that is not covered by the active material layer and is welded to the current collector in a welded region that is included within the exposed region.

Within a two-dimensional flat surface onto which the power generation element is projected, lengths La and Lb and areas Sa and Sb are defined. The length La is a length from an end portion of the exposed region overlapping with the electrode terminal to a position in which the welded region is formed in the direction in which the electrode terminal extends. The length Lb is a length of the exposed region in the direction in which the electrode terminal extends. The area Sa is an area of the welded region and the area Sb is an area of the exposed region.

A ratio La/Lb between the lengths La and Lb is defined as a first ratio, and a ratio Sa/Sb between the areas Sa and Sb is defined as a second ratio. The first and second ratios are positioned within a region surrounded by lines connecting five points P1 to P5 in a coordinate system in which the first and second ratios are taken as the respective coordinate axes thereof.

The point P1 has a first ratio of 0.273 and a second ratio of 0.099. The point P2 has a first ratio of 0.636 and a second ratio of 0.099. The point P3 has a first ratio of 0.836 and a second ratio of 0.496. The point P4 has a first ratio of 0.545 and a second ratio of 0.496. The point P5 has a first ratio of 0.236 and a second ratio of 0.215.

When manufacturing the lithium ion secondary battery, the first ratio and the second ratio can be set such that the first ratio and the second ratio are included within the region surrounded by the points P1 to P5. As a position of the welded region can be determined by the lengths La and Lb, the position of the welded region can be determined by setting the first ratio. As an area of the welded region can be determined by the areas Sa and Sb, the area of the welded region can be determined by setting the second ratio.

According to the present invention, an amount of lithium deposition can be reduced by setting the first ratio and the second ratio within the region surrounded by the points P1 to P5. By reducing the amount of lithium deposition, it is possible to prevent deterioration of the lithium ion secondary battery (such as a decrease in capacity, for example).

The power generation element can be formed by a flat portion and a curvature portion. In the flat portion, the electrode plates and the separator are laminated together along a flat surface, the flat portion including the welded region. The curvature portion is continuous with the flat portion, and in the curvature portion, the electrode plates and the separator are bent. After rolling a laminated body of the electrode plates and the separator, by processing part of the laminated body so as to extend along a flat surface, it is possible to obtain the power generation element formed by the flat portion and the curvature portion.

The electrode plates include a negative electrode plate and a positive electrode plate. The electrode terminals include a negative electrode terminal connected to the negative electrode plate and a positive electrode terminal connected to the positive electrode plate. With respect to at least one of the positive electrode plate and the negative electrode plate, the first ratio and the second ratio can be set to values included within the region surrounded by the points P1 to P5.

The current collector of the positive electrode plate and the positive electrode terminal can be formed of aluminum, for example. Further, the current collector of the negative electrode plate and the negative electrode terminal can be formed of copper, for example. The lithium ion secondary battery can be mounted in a vehicle. More specifically, energy output from the lithium ion secondary battery can be used as kinetic energy for running a vehicle.

### BRIEF DESCRIPTION OF DRAWINGS

FIG. 1 is an external view of a secondary battery.

FIG. 2 is a schematic diagram illustrating the internal structure of the secondary battery.

FIG. 3 is a development view of part of a power generation element.

FIG. 4 is a cross-sectional view of part of the power generation element.

FIG. 5 is a view illustrating a relationship between a length of a negative electrode tab and an area of a welded region.

FIG. 6 is an enlarged view of a connection portion of the power generation element and the negative electrode tab.

FIG. 7 is a side view of the connection portion of the power generation element and the negative electrode tab.

FIG. 8 is an enlarged view of the welded region.

### DESCRIPTION OF EMBODIMENTS

Hereinafter, embodiments of the present invention will be described.

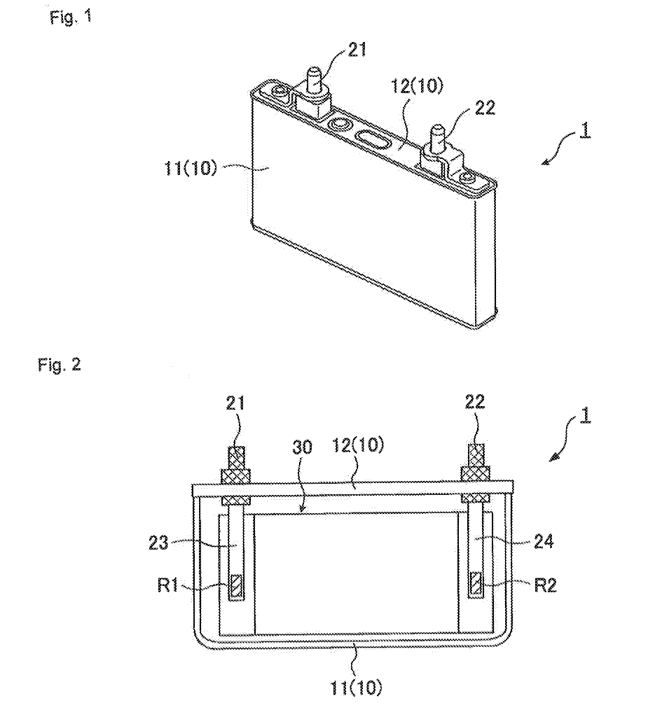

FIG. 1 is an external view of a secondary battery according to the present embodiment. FIG. 2 is a schematic diagram illustrating the internal structure of the secondary battery. As a secondary battery 1, a lithium ion secondary battery is used. The secondary battery 1 has a battery case 10 and a power generation element 30 housed in the battery case 10. The battery case 10 has a case main body 11 and a lid 12 and can be formed of metal, such as aluminum.

The case main body 11 has an opening to house the power generation element 30 and the lid 12 covers the opening of the case main body 11. The lid 12 is fixed to the case main body 11 by welding or the like and the inside of the battery case 10 is in a sealed state. The battery case 10 is formed in a shape following a rectangular parallelepiped and the secondary battery 1 is a so-called square battery.

A negative electrode terminal 21 and a positive electrode terminal 22 are fixed to the lid 12. Each of the negative electrode terminal 21 and the positive electrode terminal 22 has a portion that is positioned outside the battery case 10 and a portion that is positioned inside the battery case 10. A negative electrode tab 23 is housed in the battery case 10 and connected to the negative electrode terminal 21 and the power generation element 30. The negative electrode tab 23 is welded to the power generation element 30 (a negative electrode plate 31 that will be descried below) in a welded region R1.

The negative electrode tab 23 is used to connect the power generation element 30 to a load and has the same function as the negative electrode terminal 21. Therefore, the negative electrode terminal 21 and the negative electrode tab 23 are considered to be a terminal of the secondary battery 1 (equivalent to an electrode terminal). In the present embodiment, the negative electrode terminal 21 and the negative electrode tab 23 are separate members, but the negative electrode terminal 21 and the negative electrode tab 23 can be formed integrally. The negative electrode tab 23 can be formed of copper, for example.

A positive electrode tab 24 is housed in the battery case 10 and connected to the positive electrode terminal 22 and the power generation element 30. The positive electrode tab 24 is welded to the power generation element 30 (a positive electrode plate 32 that will be described below) in a welded region R2.

The positive electrode tab 24 is used to connect the power generation element 30 to the load and has the same function as the positive electrode terminal 22. Therefore, the positive electrode terminal 22 and the positive electrode tab 24 are considered to be a terminal of the secondary battery 1 (equivalent to an electrode terminal). In the present embodiment, the positive electrode terminal 22 and the positive electrode tab 24 are separate members, but the positive electrode terminal 22 and the positive electrode tab 24 can be formed integrally. The positive electrode tab 24 can be formed of aluminum, for example.

The secondary battery 1 can be mounted in a vehicle. More specifically, an assembled battery can be formed by using a plurality of the secondary batteries 1 and the assembled battery can be mounted in the vehicle. The assembled battery can be used as a power source for running the vehicle. More specifically, electric energy that is outputted from the assembled battery can be converted into kinetic energy for running the vehicle. Further, kinetic energy generated when braking the vehicle (regenerative energy) can be stored in the assembled battery after being converted into electric energy.

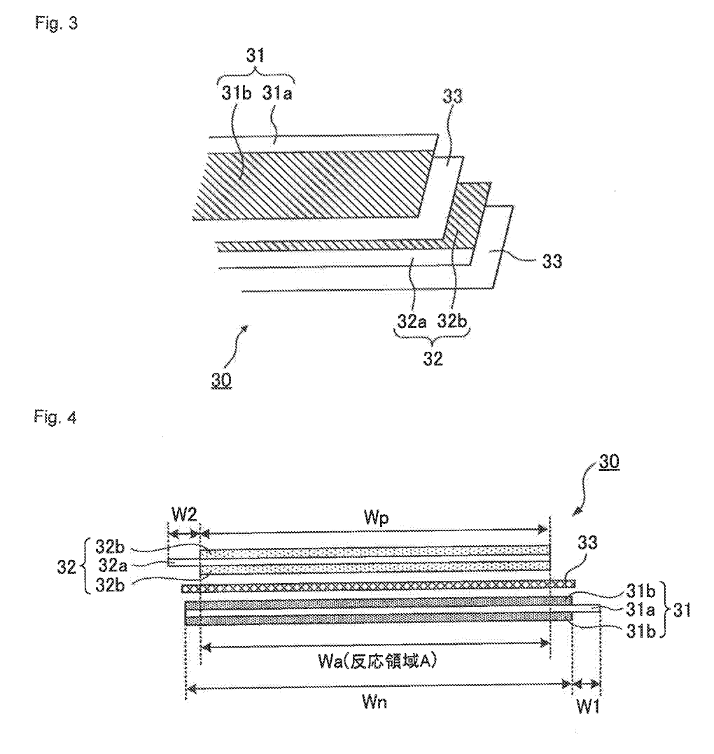

FIG. 3 is a development view of part of the power generation element 30. The power generation element 30 is an element that performs charging and discharging. The power generation element 30 has a negative electrode plate 31 (equivalent to an electrode plate), a positive electrode plate 32 (equivalent to an electrode plate), and a separator 33.

The negative electrode plate 31 has a current collector 31a and a negative electrode active material layer 31b that is formed on the surface of the current collector 31a. The negative electrode active material layer 31b is formed on both surfaces of the current collector 31a. The negative electrode active material layer 31b is formed in a region of part of the current collector 31a, and the current collector 31a is exposed at one end of the negative electrode plate 31. The negative electrode active material layer 31b includes a negative electrode active material, a conductive material, a binder, and the like. As the negative electrode active material, carbon can be used, for example. The negative electrode plate 31 can be manufactured by applying the materials constituting the negative electrode active material layer 31b to the current collector 31a.

The positive electrode plate 32 has a current collector 32a and a positive electrode active material layer 32b that is formed on the current collector 32a. The positive electrode active material layer 32b is formed on both surfaces of the current collector 32a. The positive electrode active material layer 32b is formed in a region of part of the current collector 32a, and the current collector 32a is exposed at one end of the positive electrode plate 32. The positive electrode active material layer 32b includes a positive electrode active material, a conductive material, a binder, and the like. As the positive electrode active material, LiCoO₂, LiMn₂O₄, LiNiO₂, LiFePO₄, Li₂FePO₄F, LiCo_{1/3}Ni_{1/3}Mn_{1/3}O₂ or Li (LiₐNiₓMn_{y}Co_{z}) O₂ can be used, for example. The positive electrode plate 32 can be manufactured by applying the materials constituting the positive electrode active material layer 32b to the current collector 32a.

The separator 33 is arranged between the negative electrode plate 31 and the positive electrode plate 32. The separator 33, the negative electrode active material layer 31b, and the positive electrode active material layer 32b are impregnated with an electrolytic solution. The power generation element 30 has the two separators 33, and the positive electrode plate 32 is arranged between the two separators 33.

As shown in FIG. 3, the negative electrode plate 31, the positive electrode plate 32, and the separator 33 are laminated together to form a laminated body and the power generation element 30 is formed by rolling the laminated body. At one end of the power generation element 30, only the negative electrode plate 31 (particularly the current collector 31a) is rolled, and in a portion in which the current collector 31a is rolled, as shown in FIG. 2, the negative electrode tab 23 is welded at the welded region R1. At the other end of the power generation element 30, only the positive electrode plate 32 (particularly the current collector 32a) is rolled, and in a portion in which the current collector 32a is rolled, as shown in FIG. 2, the positive electrode tab 24 is welded at the welded region R2.

FIG. 4 is a cross-sectional view of the negative electrode plate 31, the positive electrode plate 32, and the separator 33. The negative electrode active material layer 31b and the positive electrode active material layer 32b face each other with the separator 33 interposed therebetween. A region in which the negative electrode active material layer 31b and the positive electrode active material layer 32b mutually face each other is a region (a reaction region A) in which chemical reactions take place by charging and discharging of the secondary battery 1. In the reaction region A, according to the charging and discharging of the secondary battery 1, lithium ions move between the negative electrode plate 31 and the positive electrode plate 32.

As shown in FIG. 4, in the present embodiment, since a width Wn of the negative electrode active material layer 31b is wider than a width Wp of the positive electrode active material layer 32b, a width Wa of the reaction region A is equal to the width Wp of the positive electrode active material layer 32b. Here, the width Wp of the positive electrode active material layer 32b can be made wider than the width Wn of the negative electrode active material layer 31b. In this case, the width Wa of the reaction region A becomes equal to the width Wn of the negative electrode active material layer 31b.

A width W1 shown in FIG. 4 represents a width of a region, of the current collector 31a of the negative electrode plate 31, which is not covered by the negative electrode active material layer 31b (equivalent to an exposed region). A width W2 represents a width of a region, of the current collector 32a of the positive electrode plate 32, which is not covered by the positive electrode active material layer 32b (equivalent to an exposed region).

It has been found that an amount of lithium deposition in the power generation element 30 changes by changing positions and/or areas of the welded regions R1 and R2. Table 1 shows measurement results of the amount of lithium deposition in the power generation element 30 when the positions and/or areas of the welded regions R1 and R2 are changed.

The amount of lithium deposition is indicated as a percentage of the amount of lithium deposition out of a total amount of lithium ions contained in the power generation element 30. A length ratio (La/Lb) shown in Table 1 is a value that identifies the positions of the welded regions R1 and R2 and will be described below in detail. An area ratio (Sa/Sb) shown in Table 1 is a value that identifies the areas of the welded regions R1 and R2 and will be described below in detail.

TABLE 1

| | | | LITHIUM |
|---|---|---|---|
| | | | DEPOSITION |
| TEST | LENGTH RATIO | AREA RATIO | AMOUNT |
| NO. | (La/Lb) | (Sa/Sb) | [%] |
| 1 | 0.273 | 0.099 | 7 |
| 2 | 0.455 | 0.099 | 6 |
| 3 | 0.636 | 0.099 | 7 |
| 4 | 0.727 | 0.298 | 6 |
| 5 | 0.836 | 0.496 | 7 |
| 6 | 0.691 | 0.496 | 6 |
| 7 | 0.545 | 0.496 | 7 |
| 8 | 0.400 | 0.364 | 6 |
| 9 | 0.236 | 0.215 | 7 |
| 10 | 0.582 | 0.248 | 3 |
| 11 | 0.182 | 0.099 | 21 |
| 12 | 0.400 | 0.050 | 25 |
| 13 | 0.691 | 0.066 | 24 |
| 14 | 0.800 | 0.298 | 22 |
| 15 | 0.909 | 0.579 | 28 |
| 16 | 0.727 | 0.579 | 22 |
| 17 | 0.390 | 0.067 | 20 |

Experiment conditions in which results shown in Table 1 were obtained will be described.

As the positive electrode active material of the positive electrode active material layer 32b, LiNi_{0.33}Co_{0.33}Mn_{0.33}O₂ was used, and as the negative electrode active material of the negative electrode active material layer 31b, carbon was used. As the electrolytic solution, a solution in which LiPF₆ was mixed with a combined solvent of EC (Ethylene Carbonate), DMC (Dimethyl Carbonate), and EMC (Ethyl Methyl Carbonate) was used.

As the separator 33, three films layered to one another were used. More specifically, a film formed of PE (Polyethylene) was interpositioned between two films formed of PP (Polypropylene) to form the separator 33. A ratio (Cn/Cp) between a capacity Cn of the negative electrode plate 31 and a capacity Cp of the positive electrode plate 32 was 1.05. A capacity of the secondary battery 1 was 4 [Ah] and a thickness of a negative electrode tab 23 and a positive electrode tab 24 was 1 [mm].

Charging was performed for 0.1 [sec] at a current value of 240 [A] in a state in which the secondary battery 1 was placed in a thermostatic chamber of −30° C. This charging process was performed 4000 times and the amount of lithium deposition in the power generation element 30 was measured.

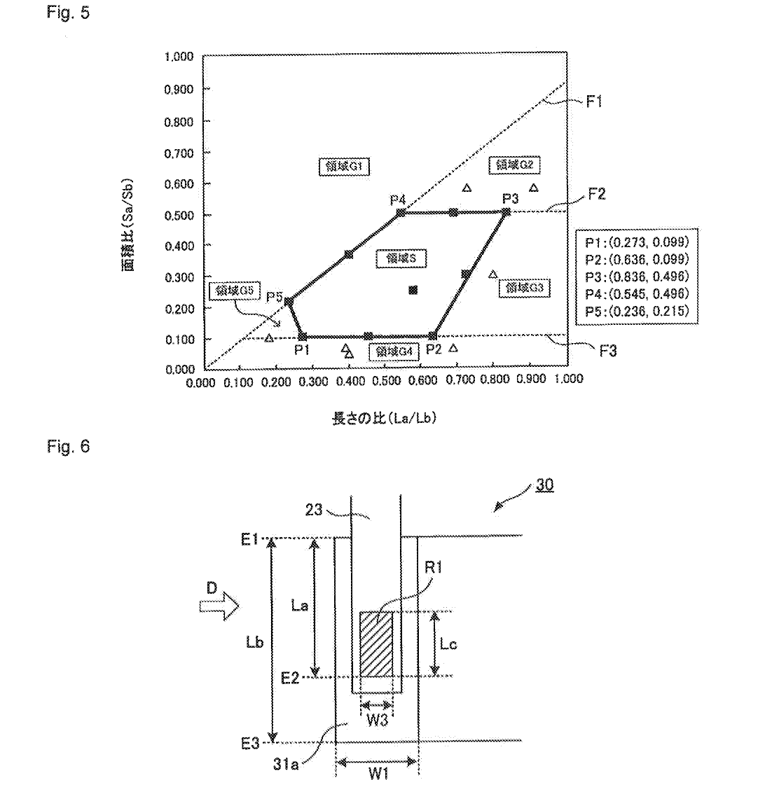

FIG. 5 is a diagram in which the results shown in Table 1 are plotted. In FIG. 5, the horizontal axis is the length ratio (La/Lb) and the vertical axis is the area ratio (Sa/Sb).

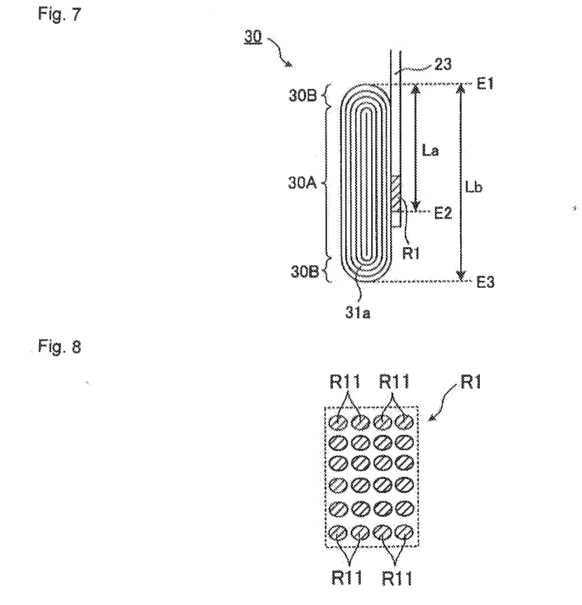

The length ratio (La/Lb) shown in Table 1 represents a ratio between a length La and a length Lb shown in FIG. 6 and FIG. 7. FIG. 6 is an enlarged view of a connection portion of the negative electrode tab 23 and the power generation element 30 (the current collector 31a). FIG. 7 is a side view of the connection portion of the negative electrode tab 23 and the power generation element 30 (the current collector 31a) and is a view in which the power generation element 30 is viewed from the direction indicated by an arrow D in FIG. 6. Although FIG. 6 and FIG. 7 illustrate the connection portion of the negative electrode tab 23 and the power generation element 30, a connection portion of the positive electrode tab 24 and the power generation element 30 has the same structure as that shown in FIG. 6 and FIG. 7.

Although the power generation element 30 has a three-dimensional shape, the lengths La and Lb are defined on a flat surface that is obtained when the power generation element 30 is projected on a two-dimensional flat surface.

As the power generation element 30 is processed into a flat shape after rolling the laminated body formed of the negative electrode plate 31, the positive electrode plate 32, and the separator 33, the power generation element 30 has a flat portion 30A and a curvature portion 30B as shown in FIG. 7. After rolling the laminated body formed of the negative electrode plate 31, the positive electrode plate 32, and the separator 33, by processing part of the laminated body along a flat surface, the power generation element 30 has the flat shape. In the flat portion 30A, the negative electrode plate 31, the positive electrode plate 32, and the separator 33 are laminated together along a flat surface. In the curvature portion 30B, the laminated body formed of the negative electrode plate 31, the positive electrode plate 32, and the separator 33 is bent.

The negative electrode tab 23 and the positive electrode tab 24 are arranged along the flat portion 30A, and the welded regions R1 and R2 are positioned in the flat portion 30A. More specifically, as shown in FIG. 6, the negative electrode tab 23 extends in one direction (a vertical direction in FIG. 6) along the region around which only the current collector 31a is rolled. The curvature portion 30B is a portion in which the laminated body formed of the negative electrode plate 31, the positive electrode plate 32, and the separator 33 is bent.

A flat surface that defines the lengths La and Lb is a flat surface along the flat portion 30A. In other words, the flat surface that defines the lengths La and Lb is a two-dimensional flat surface that is obtained when the power generation element 30 is viewed from the direction orthogonal to the welded region R1.

As shown in FIG. 6 and FIG. 7, the length La is a distance between an upper end portion E1 of the region around which only the current collector 31a of the negative electrode plate 31 is rolled and a lower end portion E2 of the welded region R1. The length La is a length in the direction in which the negative electrode tab 23 extends.

As shown in FIG. 6, the upper end portion E1 is an end portion, which overlaps with the negative electrode tab 23, in the region around which only the current collector 31a is rolled. The lower end portion E2 of the welded region R1 is an end portion, which is positioned on a side of a lower end portion E3 of the region around which only the current collector 31a is rolled, in the welded region R1. More specifically, the length La is a length that includes the welded region R1. As shown in FIG. 6, the lower end portion E3 is an end portion, which does not overlap with the negative electrode tab 23, in the region around which only the current collector 31a is rolled.

The length Lb is a distance between the upper end portion E1 and the lower end portion E3 in the region around which only the current collector 31a of the negative electrode plate 31 is rolled. The length Lb is a length in the direction in which the negative electrode tab 23 extends. Based on the lengths La and Lb, the position of the welded region R1 can be identified.

The area ratio (Sa/Sb) shown in Table 1 represents a ratio between an area Sa and an area Sb. The areas Sa and Sb are defined in the same flat surface as the two-dimensional flat surface that defines the lengths La and Lb. As shown in FIG. 6 and FIG. 7, the area Sa is an area of the welded region R1.

As shown in FIG. 6, when the welded region R1 is formed in a rectangular shape, the area Sa is obtained by multiplying the width W3 of the welded region R1 by a length Lc of the welded region R1 in the vertical direction of the power generation element 30. The length Lc is the length of the welded region R1 in the longitudinal direction of the negative electrode tab 23. The width W3 is the length of the welded region R1 in the direction orthogonal to the longitudinal direction of the negative electrode tab 23.

The area Sb is an area of the region around which only the current collector 31a of the negative electrode plate 31 is rolled. The area Sb is obtained by multiplying the length Lb by the width W1 of the region around which only the current collector 31a is rolled. The width W1 shown in FIG. 6 is a width of a region, which is not covered by the negative electrode active material layer 31b, on the current collector 31a and corresponds to the width W1 shown in FIG. 4.

Welding of the negative electrode tab 23 and the current collector 31a is performed using a jig. Here, when a plurality of spot weldings are performed in the welded region R1, as shown in FIG. 8, a plurality of welded regions R11 are generated. The number of the welded regions R11 is equal to the number of the spot weldings As shown in FIG. 8, when a plurality of spot weldings R11 exists, the area Sa of the welded region is a sum of areas of the welded regions R11.

Also in the connection portion of the positive electrode tab 24 and the power generation element 30 (current collector 32a), the lengths La and Lb and the areas Sa and Sb are defined in the same manner as illustrated in FIG. 6 and FIG. 7.

The length ratio (La/Lb) and the area ratio (Sa/Sb) are set to values included within a region S shown in FIG. 5. The region S is a region surrounded by five points P1 to P5, and as illustrated in FIG. 5, it is a region surrounded by lines connecting the points P1 to P5. More specifically, the region S is a region surrounded by a line connecting the points P1 and P2, a line connecting the points P2 and P3, a line connecting points P3 and P4, a line connecting the points P4 and P5, and a line connecting the points P5 and P1. The length ratio (La/Lb) and the area ratio (Sa/Sb) may be positioned on an outer edge of the region S, namely, on the line connecting two of the points.

At the point P1, the length ratio (La/Lb) is 0.273 and the area ratio (Sa/Sb) is 0.099. The point P1 corresponds to test No. 1 shown in Table 1. At the point P2, the length ratio (La/Lb) is 0.636 and the area ratio (Sa/Sb) is 0.099. The point P2 corresponds to test No. 3 shown in Table 1. At the point P3, the length ratio (La/Lb) is 0.836 and the area ratio (Sa/Sb) is 0.496. The point P3 corresponds to test No. 5 shown in Table 1.

At the point P4, the length ratio (La/Lb) is 0.545 and the area ratio (Sa/Sb) is 0.496. The point P4 corresponds to test No. 7 shown in Table 1. At the point P5, the length ratio (La/Lb) is 0.236 and the area ratio (Sa/Sb) is 0.215. The point P5 corresponds to test No. 9 shown in Table 1.

In the region S, the amount of lithium deposition can be reduced compared with that in a region positioned outside the region S. Tests No. 1 to 10 shown in Table 1 are included within the region S, and as shown in Table 1, the amounts of lithium deposition (deposition percentage) can be held down to one digit values. On the other hand, tests No. 11 to 17 are positioned outside the region S, and as shown in Table 1, the amounts of lithium deposition (deposition percentage) became two digit values. Therefore, by setting the length ratio (La/Lb) and the area ratio (Sa/Sb) to the values included within the region S, the amount of lithium deposition can be reduced.

In FIG. 5, a region G1, which is positioned on a side of smaller length ratios (La/Lb) with respect to a border line F1, is a region in which the length ratio (La/Lb) and the area ratio (Sa/Sb) cannot be set in experiments from which the results shown in Table 1 are obtained.

In a region G2 surrounded by the border line F1 and a border line F2, it is considered that the amount of lithium deposition increases, since the area of the welded region R1 becomes too large. The border line F2 is a line running along the line connecting the points P3 and P4. When the area of the welded region R1 is increased, heat dissipation in the welded region R1 is improved and the temperature of the welded region R1 is lowered more easily. If the temperature of the welded region R1 is lowered more easily, then the resistance of the welded region R1 increases more easily, and it is considered that the amount of lithium deposition increases as a result thereof.

In a region G3, which is positioned on a side of larger length ratios (La/Lb) with respect to the line connecting the points P2 and P3, since the length La becomes too long with respect to the length Lb, the resistance of the negative electrode tab 23 increases. It is considered that the amount of lithium deposition increases as a result of the increase in the resistance of the negative electrode tab 23.

In a region G4, which is positioned on a side of smaller area ratios (Sa/Sb) with respect to a border line F3, it is considered that the amount of lithium deposition increases, since the area ratio (Sa/Sb) becomes too small and the current density increases. The border line F3 is a line running along the line connecting the points P1 and P2. The smaller the area ratio (Sa/Sb) becomes, the smaller the welded region R1 gets. As a current pathway between the power generation element 30 and the negative electrode tab 23 is the welded region R1, when the welded region R1 becomes smaller, the current density increases.

In a region G5, which is surrounded by the border lines F1 and F3 and the line connecting the points P1 and P5, it is considered that the amount of lithium deposition increases as a result of unevenness being generated in a current flowing through the negative electrode tab 23 and the current collector 31a. In the region G5, the length La becomes too small or the area Sa of the welded region R1 becomes too small. Hence, when the length ratio (La/Lb) and the area ratio (Sa/Sb) are set to values included within the region G5, unevenness is more easily generated in the current flowing through the negative electrode tab 23 and the current collector 31a.

Although, in the present embodiment, the length ratio (La/Lb) and the area ratio (Sa/Sb) are set to the values included within the region S shown in FIG. 5 with respect to the welded regions R1 and R2, the present invention is not limited thereto. More specifically, the length ratio (La/Lb) and the area ratio (Sa/Sb) can be set to the values included within the region S shown in FIG. 5 with respect to one of the welded regions R1 and R2.

The positions and areas of the welded regions R1 and R2 can be identified using parameters different from those described in the present embodiment (the lengths La and Lb and the areas Sa and Sb). However, when the lengths La and Lb and the areas Sa and Sb are defined on the two-dimensional flat surface described in the present embodiment, it is sufficient that the length ratio (La/Lb) and the area ratio (Sa/Sb) are set to the values included within the above-described region S.

1. A lithium ion secondary battery comprising:
a power generation element having electrode plates each having a current collector and an active material layer that covers part of the current collector, the electrode plates being rolled together with a separator interposed therebetween, the power generation element configured to perform charging and discharging; and
electrode terminals extending along an exposed region on the current collector that is not covered by the active material layer, the electrode terminals being welded to the current collector in a welded region that is included within the exposed region, wherein
within a two-dimensional flat surface onto which the power generation element is projected, when a ratio La/Lb of a length La to a length Lb is defined as a first ratio and a ratio of Sa/Sb of an area Sa of the welded region to an area Sb of the exposed region is defined as a second ratio, the length La being a length from an end portion of the exposed region overlapping with the electrode terminal to a position in which the welded region is formed in a direction in which the electrode terminal extends, the length Lb being a length of the exposed region in the direction in which the electrode terminal extends,
the first and second ratios are positioned within a region surrounded by lines connecting five points P1 to P5 in a coordinate system in which the first and second ratios are taken as respective coordinate axes thereof,
where the point P1 has a first ratio of 0.273 and a second ratio of 0.099,
the point P2 has a first ratio of 0.636 and a second ratio of 0.099,
the point P3 has a first ratio of 0.836 and a second ratio of 0.496,
the point P4 has a first ratio of 0.545 and a second ratio of 0.496, and
the point P5 has a first ratio of 0.236 and a second ratio of 0.215.

2. The lithium ion secondary battery according to claim 1, wherein the power generation element includes:
a flat portion including the welded region, with the electrode plates and the separator being laminated together along a flat surface; and
a curvature potion continuous with the flat portion, with the electrode plates and the separator being bent.

3. The lithium ion secondary battery according to claim 1, wherein
the electrode plates include a negative electrode plate, and
the electrode terminals include a negative electrode terminal connected to the negative electrode plate.

4. The lithium ion secondary battery according to claim 1, wherein
the electrode plates include a positive electrode plate and a negative electrode plate,
the electrode terminals include a positive electrode terminal connected to the positive electrode plate and a negative electrode terminal connected to the negative electrode plate, and
the current collector of the positive electrode plate and the positive electrode terminal are formed of aluminum and the current collector of the negative electrode plate and the negative electrode terminal are formed of copper.

5. The lithium ion secondary battery according to claim 1, wherein the lithium ion secondary battery outputs energy used as kinetic energy for running a vehicle.

6. A method of manufacturing a lithium ion secondary battery, wherein the lithium ion secondary battery includes:
a power generation element having electrode plates each having a current collector and an active material layer that covers part of the current collector, the electrode plates being rolled together with a separator interposed therebetween, the power generation element configured to perform charging and discharging; and
electrode terminals extending along an exposed region on the current collector that is not covered by the active material layer, the electrode terminals being welded to the current collector in a welded region that is included within the exposed region, wherein
within a two-dimensional flat surface onto which the power generation element is projected, when a ratio La/Lb of a length La to a length Lb is defined as a first ratio and a ratio of Sa/Sb of an area Sa of the welded region to an area Sb of the exposed region is defined as a second ratio, the length La being a length from an end portion of the exposed region overlapping with the electrode terminal to a position in which the welded region is formed in a direction in which the electrode terminal extends, the length Lb being a length of the exposed region in the direction in which the electrode terminal extends,
the first and second ratios are set to be positioned within a region surrounded by lines connecting five points P1 to P5 in a coordinate system in which the first and second ratios are taken as respective coordinate axes thereof,
where the point P1 has a first ratio of 0.273 and a second ratio of 0.099,
the point P2 has a first ratio of 0.636 and a second ratio of 0.099,
the point P3 has a first ratio of 0.836 and a second ratio of 0.496,
the point P4 has a first ratio of 0.545 and a second ratio of 0.496, and
the point P5 has a first ratio of 0.236 and a second ratio of 0.215.

7. The method of manufacturing a lithium ion secondary battery according to claim 6, comprising
rolling a laminated body of the electrode plates and the separator to form, in the power generation element, a flat portion including the welded region with the electrode plates and the separator being laminated together along a flat surface, and a curvature potion continuous with the flat portion, with the electrode plates and the separator being bent.

8. The method of manufacturing a lithium ion secondary battery according to claim 6, wherein
the electrode plates include a negative electrode plate, and
the electrode terminals include a negative electrode terminal connected to the negative electrode plate.

9. The method of manufacturing a lithium ion secondary battery according to claim 6, wherein
the electrode plates include a positive electrode plate and a negative electrode plate,
the electrode terminals include a positive electrode terminal connected to the positive electrode plate and a negative electrode terminal connected to the negative electrode plate, and
the current collector of the positive electrode plate and the positive electrode terminal are formed of aluminum and the current collector of the negative electrode plate and the negative electrode terminal are formed of copper.
